(19) United States
(12) Patent Application Publication
(10) Pub. No.: US 2010/0079248 A1
(43) Pub. Date: Apr. 1, 2010

(54) Optical fiber connector assembly with wire-based RFID antenna

(76) Inventor: Johannes Ian Greveling, Newton, NC (US)

Correspondence Address: CORNING INCORPORATED, INTELLECTUAL PROPERTY DEPARTMENT, SP-TI-3-1, CORNING, NY, 14831, US

(21) Appl. No.: 12/286,183

(22) Filed: Sep. 29, 2008

(51) Int. Cl. G02B 6/36; H04B 7/00

(52) U.S. Cl. 340/10.1; 385/53

(57) ABSTRACT

An optical fiber connector assembly (10) that provides improved radio-frequency (RF) antenna capability for a radio-frequency identification (RFID) tag (200). The assembly includes a connectorized fiber optic cable (150) having a connector (11). The assembly also includes a wire (246) that either is connected to the RFID tag or is configured to electrically connect to the RFID tag. The wire runs alongside a portion of the fiber optic cable length and is loosely held thereto. The wire serves as at least a portion of an RFID antenna (220) for the RFID tag. The RFID tag may be supported by the connector or may be supported by a connector adapter that is configured to operably engage the connector. The optical fiber connector assembly allows for improved RF antenna capability that provides improved RF communication with an RF reader (400), particularly in RFID applications where existing RFID tag antennas are inadequate. The wire can also serve as substantially the entire RFID antenna, thereby obviating the need to include an RFID antenna as part of the RFID tag.

### TECHNICAL FIELD

This application relates generally to the use of radio-frequency identification (RFID) systems as used in telecommunication systems, and in particular is directed to optical fiber connector assemblies that have wire-based RFID antennas.

### BACKGROUND

Typical telecommunications data centers include large numbers of optical and electrical cable connections that join various types of network equipment. Examples of network equipment include electrically-powered (active) units such as servers, switches and routers, and unpowered (passive) units such as fanout boxes and patch panels. This network equipment is often installed within cabinets in standard (e.g., 19″) equipment racks. Each piece of equipment typically provides one or more adapters where optical or electrical patch cables can be physically connected to the equipment. These patch cables are generally routed to other network equipment located in the same cabinet or another cabinet.

A common problem in telecommunications data center management is determining the latest configuration of all the optical and electrical links among all the network equipment. The configuration of optical and electrical links can be completely determined if the physical locations of all connected patch cable (or “jumper cable”) connectors on installed network equipment are known.

Information about the physical location and connection status of the patch cables and their corresponding ports in a data center cabinet is typically manually recorded and added to a network management software database. Unfortunately, this process is labor-intensive and prone to errors. Additionally, any changes made to the physical configuration of a cabinet must be followed up with corresponding changes to the network management software database, which delays providing the most up-to-date information about the network configuration. Furthermore, errors from manual recording and entering configuration data tend to accumulate over time, reducing the trustworthiness of the network management software database.

It is particularly important to be able to perform connector-port identifications quickly and reliably. It is therefore desirable to be able to automatically and remotely identify individual connections (i.e., connector-port connections) in a telecommunications cabinet. Current commercially available automated solutions utilize an overlay of copper wiring, which adds cost and complexity to the cabinet while providing only a limited ability to perform connector-port identifications.

While RFID systems have been employed in telecommunication systems to identify system components, one of the difficulties presented in standard “4U” telecommunication cabinets (where “U” is a standard measurement unit of 1.75″) is the density and number of the connections involved, which leaves little room for RFID tags. For example, a typical present-day 4U data center cabinet contains up to 144 ports, and if each of these ports has at least one RFID tag, then the RFID tags need to be very compact. Further, future data center cabinets are likely to include an even greater number of ports, such as about 400 ports, which translates into over 1200 tags within the 4U cabinet if each port includes three RFID tags. Such dense arrangements of RFID tags leaves very little room for RFID tag antennas that can adequately and efficiently harvest energy from the RFID interrogation signals from the RF reader and ensure that all of the tags in the relatively small volume can communicate the connector-port information to the RF reader. In some cases, standard RFID tag antennas that might work for one RFID application do not work as well for other applications such as telecommunication cabinets and like telecommunication assemblies where the density of RFID tags can interfere with RF communication between the RFID tags and the RF reader.

### SUMMARY

A first aspect of the invention is an optical fiber connector assembly that provides improved radio-frequency antenna capability for at least one RFID tag. The assembly includes a fiber optic cable having an end, a length and an outer surface, and at least one optical fiber. The assembly also includes an optical fiber connector operably connected to the fiber optic cable end. The assembly further includes at least one wire either electrically connected to the at least one RFID tag or configured to electrically connect to the at least one RFID tag. The at least one wire runs along a portion of the fiber optic cable length so as to serve as at least a portion of an RFID antenna for the at least one RFID tag.

A second aspect of the invention is a telecommunications assembly with RFID capability. The telecommunication assembly includes a plurality of connector assemblies as described briefly above, and a plurality of connector adapters having respective RFID tags and that are operably engaged with the plurality of connector assemblies so that the RFID tags are respectively electrically connected to respective wires of the corresponding connector assemblies. The telecommunications assembly also includes at least one RF reader arranged in relation to the wires so as to operably communicate with the plurality of RFID tags via the respective wires.

A third aspect of the invention is an optical fiber connector assembly that provides improved radio-frequency antenna capability for at least one RFID tag. The assembly includes a fiber optic cable having an end, a length and an outer surface. The assembly also includes an optical fiber connector operably connected to the fiber optic cable end. The assembly also includes a connector adapter configured to operably engage the optical fiber connector and that includes the at least one RFID tag. The assembly further includes at least one wire that runs along a portion of the fiber optic cable length and that is configured to electrically connect to the at least one RFID tag when the connector and connector adapter are operably engaged so as to serve as at least a portion of an RFID antenna for the at least one RFID tag.

A fourth aspect of the invention is a method of providing improved radio-frequency antenna capability for at least one RFID tag having an integrated circuit chip. The method includes providing a connectorized fiber optic cable having a length and a connector, and disposing at least one wire to run from the connector and along an outside portion of the fiber optic cable length. The method also includes electrically connecting the at least one wire to the integrated circuit chip of the RFID tag so as to serve as at least a portion of an RFID antenna for the at least one RFID tag.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute part of this specification. The drawings illustrate various exemplary embodiments of the invention, and together with the description serve to explain the principles and operations of the invention.

### BRIEF DESCRIPTION OF THE DRAWINGS

FIG. 1 is an exploded perspective view of an example embodiment of an optical fiber connector assembly (“connector assembly”) according to the present invention that supports a wire used as an RFID tag wire antenna;

FIG. 2 is a bottom-up perspective view of the assembled connector assembly of FIG. 1, showing the wire loosely secured to the fiber optic cable;

FIG. 3 is a cross-sectional view of a fiber optic cable formed from two fiber optic cables each having a single optical fiber, wherein the protective covers of the cables join to form a “figure-eight” cross-sectional shape that defines two grooves;

FIG. 4 is similar to FIG. 3, further showing the routing of the wire antenna in one of the grooves;

FIG. 5 is similar to FIG. 4, and illustrates an example embodiment wherein the connector assembly includes two wires, with one wire disposed in each groove;

FIG. 6 is a schematic side view of an example connector assembly shown with the connector mated with a connector adapter that includes an integrated circuit (IC) chip, and also showing an RF reader transmitting interrogation and write signals and receiving an RFID tag signal;

FIG. 7 is similar to FIG. 6 and illustrates an example embodiment where the connector adapter includes an RFID tag that connects to the wire supported by the connector assembly;

FIG. 8 is similar to FIG. 7, and illustrates an example embodiment where the connector adapter and connector assembly each include an RFID tag, and wherein the connector assembly supports a first wire that serves as an antenna for the connector-adapter RFID tag and also supports a second wire antenna in the connector that serves as an antenna for the connector RFID tag when the connector adapter engages with the connector;

FIG. 9 is similar to FIG. 7 and illustrates an example embodiment where the connector adapter includes two RFID tags and where the connector assembly supports two wires used as respective antennas for the two connector-adapter RFID tags;

FIG. 10A is a cross-sectional view of an example fiber optic cable that has a round cross-section and that includes a groove formed in the protective cover that at least partially accommodates a wire that serves as an RFID antenna;

FIG. 10B is similar to FIG. 10A, and shows an example embodiment wherein the protective cover includes two grooves that each at least partially accommodate a wire that serves as an RFID antenna;

FIG. 10C is similar to FIG. 10A, and illustrates an example embodiment wherein the protective cover includes a raised portion with a groove formed therein that at least partially accommodates a wire that serves as an RFID antenna;

FIG. 10D is similar to FIG. 10C, and illustrates an example embodiment wherein the protective cover includes two raised portions each with a groove formed therein that at least partially accommodates a wire that serves as an RFID antenna;

FIG. 11 is a schematic side view of an example connector adapter that includes an RFID tag and a flange that supports at least a portion of the RFID antenna;

FIG. 12 is an exploded perspective view of an example connector adapter such as shown in FIG. 11;

FIG. 13 is a perspective diagram of an example RFID tag and RFID antenna for use in combination with the connector adapter of FIG. 11 and FIG. 12;

FIG. 14 is a schematic close-up cross-sectional diagram of a portion of a telecommunications assembly in the form of a patch panel assembly that includes connector adapters with optical fiber connector assemblies engaged therewith (shown in side view), and also showing an RF reader; and

FIG. 15 is a schematic diagram of an example embodiment of a telecommunications assembly in the form of a telecommunications rack that has RFID capability integrated therewith and that employs optical fiber connector assemblies of the present invention.

### DETAILED DESCRIPTION OF THE INVENTION

Reference is now made in detail to the present preferred embodiments of the invention, examples of which are illustrated in the accompanying drawings. Whenever possible, like or similar reference numerals are used throughout the drawings to refer to like or similar parts. Various modifications and alterations may be made to the following examples within the scope of the present invention, and aspects of the different examples may be mixed in different ways to achieve yet further examples. Accordingly, the true scope of the invention is to be understood from the entirety of the present disclosure, in view of but not limited to the embodiments described herein.

### Optical Fiber Connector Assembly

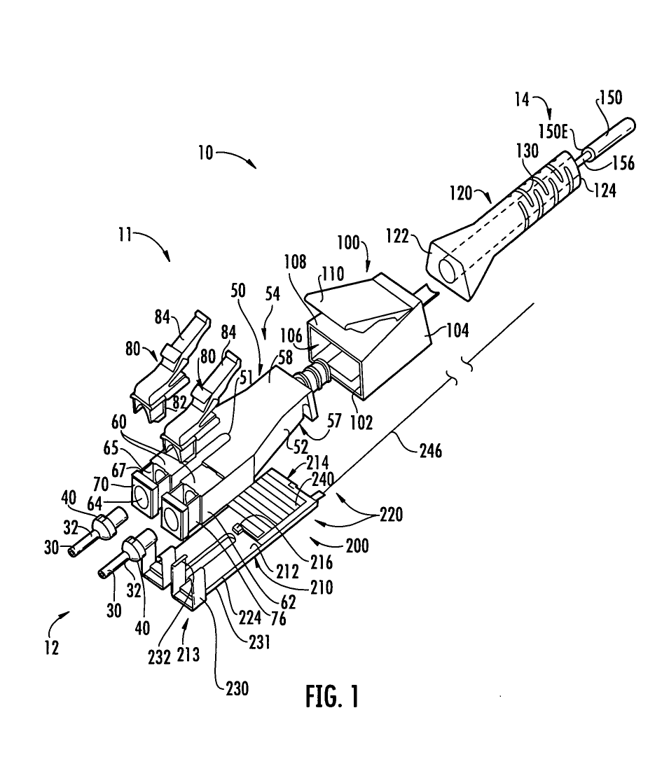

FIG. 1 is an exploded perspective view of an example embodiment of an optical fiber connector assembly (“connector assembly”) 10 that supports a wire 246 used as an RFID antenna as described in detail below. Connector assembly 10 includes an optical fiber connector (“connector”) 11 that, by way of illustration, is shown in the form of a duplex LC connector. An example LC connector 11 is described in U.S. Pat. No. 5,638,474, which is incorporated herein by reference. Connector assembly 10 has a plug end 12 at connector 11 and an opposite back end 14.

The example LC-type connector 11 of FIG. 1 includes two cylindrical ferrules 30 that are engaged at their rear end 32 by respective flanges 40. Connector 10 also includes a housing 50 having a wishbone-type housing body 52 with an output end 54. Housing body 52 includes a flat bottom portion 57 and has a bifurcation 51 at about the middle of housing body 52, thereby defining a rear housing portion 58 having a rectangular cross section that connects to square-cross-section prongs 60 that define a front housing portion. Rear housing portion 58 includes a central channel (not shown).

Each prong 60 has sides 62, a top 63 and a channel 64 formed therein. Each prong 60 includes a front end 70 open to channel 64. Channels 64 connect to the rear-portion channel at bifurcation 51 and are sized to accommodate an optical fiber. Channels 64 at front end 70 are sized to engage respective flanges 40. Prongs 60 each include on sides 62 a set of indents 76 and an aperture 65 formed in top 63 that has edges 67. Apertures 65 are configured to receive respective protrusions 82 of clip members 80 so that the clip members each reside on top 63 of respective prongs 60. Each clip member 80 includes a latch 84.

Connector 11 further includes a tapered rear flange 100 configured to fit over housing end 54. Rear flange 100 includes open front and rear ends 102 and 104, an open interior 106, and a top surface 108. Rear flange 100 also includes a trigger member 110 configured to operably engage with latches 84 when the connector is assembled.

Connector 11 also includes a bend-limiting strain-relief boot 120 having front and rear ends 122 and 124 and a central channel 130 therebetween. Boot front end 122 is configured to engage with rear flange rear end 104, and boot rear end 124 is configured to operably hold at least one fiber optic cable 150 in channel 130, as described below. Fiber optic cable 150 includes at least one optical fiber 156 and has an end 150E to which connector 11 is attached. Fiber optic cable 150 includes a protective cover 158 having an outer surface 159 and that surrounds the at least one optical fiber 156.

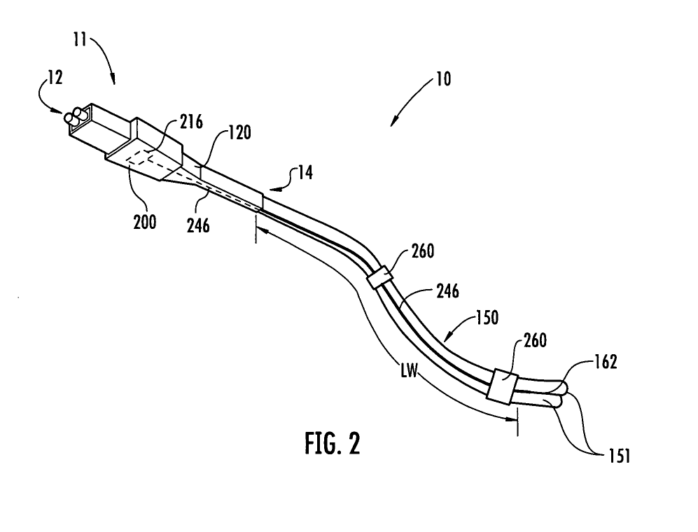

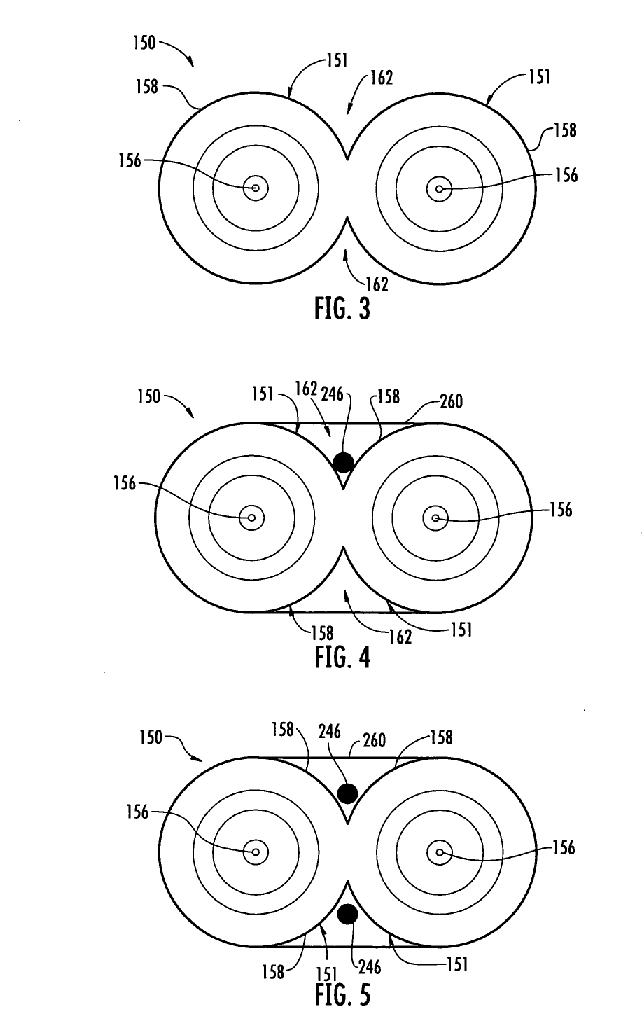

FIG. 2 is a bottom-up perspective view of the assembled connector assembly 10 of FIG. 1. FIG. 3 is a cross-sectional view of an example fiber optic cable 150 formed from two fiber optic cables 151. Each fiber optic cable 151 carries an optical fiber 156 within their respective outer protective covers 158 wherein the protective covers are joined to form a single protective cover having a “figure eight” cross-section that defines two grooves 162. Fiber optic cable 150 is said to be “connectorized” when connector 11 is operably attached to fiber optic cable end 150E.

With reference again to FIG. 1 and FIG. 2, an end portion of fiber optic cable 150 is operably held by boot 120 in boot channel 130 and the ends of the fiber optic cables are stripped so that the (bare) optical fibers 156 can be held in ferrules 30, which partially extend from connector plug end 12. Fiber optic cable 150 has a length and in an example embodiment is used to form a “jumper cable” when the length is relatively short (e.g., on the order of a meter or a few meters). Such a section of fiber optic cable 150 can also be referred to as a “zipcord.”

With continuing reference to FIG. 1 and FIG. 2, connector assembly 10 includes an RFID tag 200 attached to flat bottom portion 57 of housing body 52 of connector 11. RFID tag 200 includes a planar substrate 210 with an upper surface 212, a front end 213 and a rear end 214. RFID tag 200 includes an integrated circuit (IC) chip 216 arranged on upper surface 212, and in an example embodiment includes an antenna system (“antenna”) 220, which is electrically connected to the IC chip and which in an example embodiment is at least partially supported by substrate 210.

RFID tag 200 is adapted to store information in IC chip 216. In an example embodiment, this information includes at least one piece of data relating to the connector assembly of which it is a part. In an example embodiment, information can be written to IC chip 216.

In example embodiments, RFID tag 200 does not have a full RFID antenna 220 or any antenna, so that without wire 246 RFID tag 200 could not effectively communicate with an RF reader placed within a typical read range of the RFID tag. In another example embodiment, RFID tag 200 has a standard RFID antenna 220 or a portion of an RFID antenna 220, but this antenna or antenna portion does not provide adequate RF communication with an RF reader for the application being considered, such as in a telecommunication rack assembly that is densely packed with RFID tags as discussed briefly above and also in greater detail below. In the example embodiments where RFID tag 200 does not include an antenna 220, wire 246 electrically connects to IC chip 216 and serves as substantially the entire RFID antenna 220, thereby obviating the need to include either a full RFID antenna or an RFID antenna section on the RFID tag. This enables the RFID tag 200 to be made very small so that it can be supported by relatively small telecommunication system components such as connectors and connector adapters.

In an example embodiment, RFID tag substrate 210 includes prongs 224 at substrate front end 213 that are configured to correspond to prongs 60 of housing body 52. Arranged on prongs 60 are upwardly extending flexible electrical contacts 230 with inwardly extending tabs 232. Electrical contacts 230 fit within side indents 76, while tabs 232 serve to grip sides 67 of apertures 65 so as to hold RFID tag 200 to bottom 57 of housing body 52. In an example embodiment, electrical contacts 230 are electrically connected to RFID IC chip 216 via wiring 231 on prongs 224 of RFID tag substrate 210.

Electrical contacts 230 as shown in FIG. 1 represent one example configuration of a number of different types of electrical contact configurations that can be used, including single contacts and multiple contacts. In example embodiments of connector assembly 10 that are not intended for electrically contacting the RFID tag 200 to another IC chip or other RFID tag when the connector is engaged with a connector adapter as discussed below, contacts 230 are not necessary. Also, RFID tag 200 may be supported by connector 11 in a number of ways, including in or on the connector.

In an example embodiment, antenna system 220 includes an antenna section 240 such as a planar serpentine section formed on substrate surface 212 near substrate rear end 214 and electrically connected to IC chip 216. Antenna system 220 also includes at least one wire 246 operably connected to the planar serpentine section. Planar serpentine antenna section 240 is formed, for example, from a metal conducting film such as copper. Wire 246 preferably comprises a single, flexible conducting wire (e.g., copper wire), though multiple wires may also be used. Wire 246 is thus shown and discussed as a single wire for the sake of illustration.

In an example embodiment, wire 246 is routed through rear flange 100 and boot channel 130 of boot 120 (see dashed line in FIG. 2) and then exits the boot channel at boot rear end 114. The exposed portion of wire 246 that extends from boot 120 is preferably loosely held to fiber optic cable 150 with one or more securing members 260, e.g., one or more sections of heat-shrink wrap. The exposed portion of wire 246 serves as at least a portion of antenna 220, while the blocked portion within connector 11 serves to electrically connect the wire to RFID tag 200 (e.g., to antenna section 240 or directly to IC chip 216). In an example embodiment, a thin protective cover (not shown), such as shrink wrap, can be placed over wire 246 without significantly impacting the ability of the wire to serve as antenna. In this regard, the otherwise exposed portion of wire 246 is still considered an “exposed portion” in the context of its ability to provide RF communication to an RF reader, as one skilled in the art will appreciate.

In an example embodiment illustrated in the cross-sectional view of fiber optic cable 150 shown in FIG. 4, wire 246 is disposed in one of grooves 162. Loosely holding wire 246 to fiber optic cable 150 allows the wire to move to accommodate bending of the cable. In an example embodiment illustrated in the cross-sectional view of FIG. 5 that is similar to that of FIG. 4, the exposed portion of two wires 246 are shown disposed in respective grooves 262.

In an example embodiment, wire 246 has a length L_{W}, representing an exposed portion of the wire (see FIG. 2) in a preferred range defined by 10 cm≦L_{W}≦15 cm, and in an example embodiment L_{W}=12.5 cm. Also in an example embodiment, wire 246 has a diameter of about 0.2 mm. For certain applications, length L_{W} can either longer or shorter than that of the preferred range mentioned above, which range represents what is believed to be the most common length range suitable for most applications.

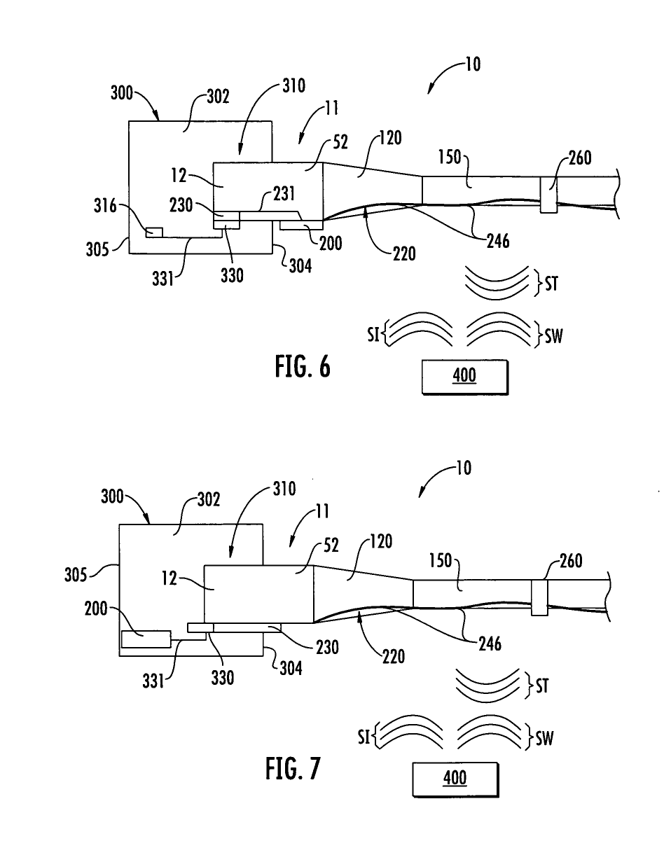

FIG. 6 is a schematic side view of an example connector assembly 10 shown with connector 11 mated with a connector adapter 300. Connector adapter 300 includes a housing 302 with a front end 304, a back end 305 and sides 306. Housing 302 defines a port (socket) 310 open at front end 304 and sized to accommodate connector plug end 12. In the example embodiment of FIG. 6, connector adapter 300 includes an IC chip 316 that includes information, such as information about the connector adapter (e.g., make, model, serial number, etc.). IC chip 316 is electrically connected to one or more electrical contacts 330 via wiring 331.

When connector 11 mates with connector adapter 300, the one or more electrical contacts 230 from the connector make contact with the one or more electrical contacts 330 of the connector adapter, thereby allowing IC chip 316 to be in electrical communication with IC chip 216 of RFID tag 200 of connector assembly 10. Electrical contact 230 is in turn electrically connected to RFID tag 200, which is electrically connected to wire 246, which runs through or along connector housing 52 and through or along connector boot 120 and then along fiber optic cable 150. Wire 246 is loosely held to fiber optic cable 150 via one or more securing members 260 as discussed above with respect to FIG. 4. This example configuration for connector assembly 10 (which in the present example embodiment also includes connector adapter 300) allows for the connector adapter to communicate information to the connector RFID tag 200, and then allows the connector RFID tag to communicate both connector and connector information via an RFID tag signal ST to an RF reader 400, which is discussed in greater detail below. Information can also be provided to IC chip 216 in connector adapter 300 via connector RFID tag 200 via a write signal SW from RF reader 400. Thus, this configuration obviates the need in certain cases for connector adapter 300 to have an RFID tag and instead include just an IC chip, thereby making good use of the limited amount of space associated with connector assembly 300.

FIG. 7 is a schematic diagram similar to FIG. 6 that illustrates an example embodiment wherein connector adapter 300 includes an RFID tag 200 and connector 11 does not include an RFID tag. In the example embodiment of FIG. 7, connector-adapter RFID tag 200 does not necessarily include a full antenna 220, but rather includes an antenna section 240, such as a serpentine section, or short wire section as represented by wiring 331 connected to electrical contact 330. In some example embodiments, RFID tag 200 does not include an antenna 220.

In an example embodiment, electrical contact 230 is a pin-type contact, such as a POGO pin. Upon engaging connector 11 and connector adapter 100, connector contact 230 contacts connector adapter contact 330, thereby establishing an electrical connection between connector-adapter RFID tag 200 and wire 246 supported by the connector and fiber optic cable 150. Wire 246 is thus able to serve as at least a portion of antenna 220 for connector-adapter RFID tag 200, and in an example embodiment, serves as substantially the entire antenna for the RFID tag.

The configuration whereby at least one wire 246 of fiber optic cable assembly 10 serves as at least a portion of antenna 220 allows for connector adapter 300 to have at least one RFID tag 200 without having to make room within, on or adjacent the connector adapter 300 for one or more full-sized antennas 220. This also allows for antenna 220 to be sufficiently long to provide a strong return signal (i.e., tag signal ST) when interrogated by an interrogation signal SI from RF reader 400 and to more easily receive write signal SW that writes information to IC chip 216. Further, wire 246 also allows antenna 220 to harvest the needed amount of power from interrogation signal SI to power the IC chip 216 within RFID tag 200. Thus, wire 246 provides improved RF communication with an RF reader as compared to using the RFID tag without the wire.

FIG. 8 is similar to FIG. 7, and illustrates an example embodiment where both connector 11 and connector adapter 300 include respective RFID tags 200. In the example embodiment of FIG. 8, the connector RFID tag 200 has an antenna 220 that includes a first wire 246 that runs along fiber optic cable 150. The connector-adapter RFID tag 200 electrically connects via contacts 230 and 330 to a second wire 246 that also runs along fiber optic cable 150, e.g., such as shown in FIG. 5. Thus, when connector 11 of connector assembly 10 engages connector adapter 300, each RFID tag 200 has at least a portion of its antenna 220 in the form of respective wires 246 supported by connector 11 and fiber optic cable 150 in the manner described above. This allows for robust communication between an RF reader and both RFID tags 200 while also making good use of limited space.

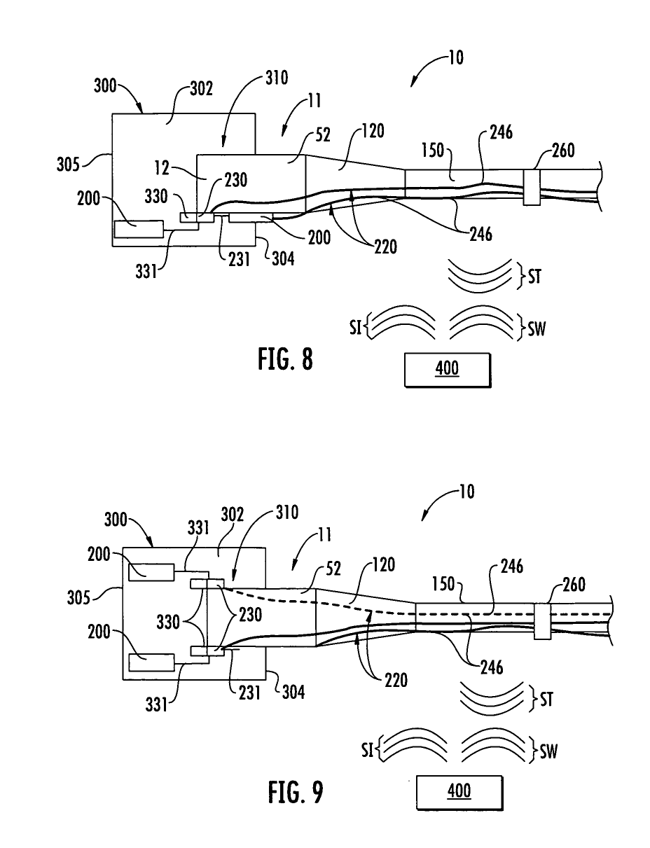

FIG. 9 is similar to FIG. 7 and illustrates an example embodiment where the connector adapter includes two RFID tags 200 and where the connector assembly 10 supports two (i.e., first and second) wires 246 that respectively serve as the antennas (or portions thereof) for the two RFID tags. One of wires 246 is shown in phantom to indicate that it is located on the opposite side of fiber optic cable 150 as the other wire. FIG. 9 thus illustrates that the present invention can accommodate a plurality of RFID tags 200 supported by connector adapter 300 and/or connector 11.

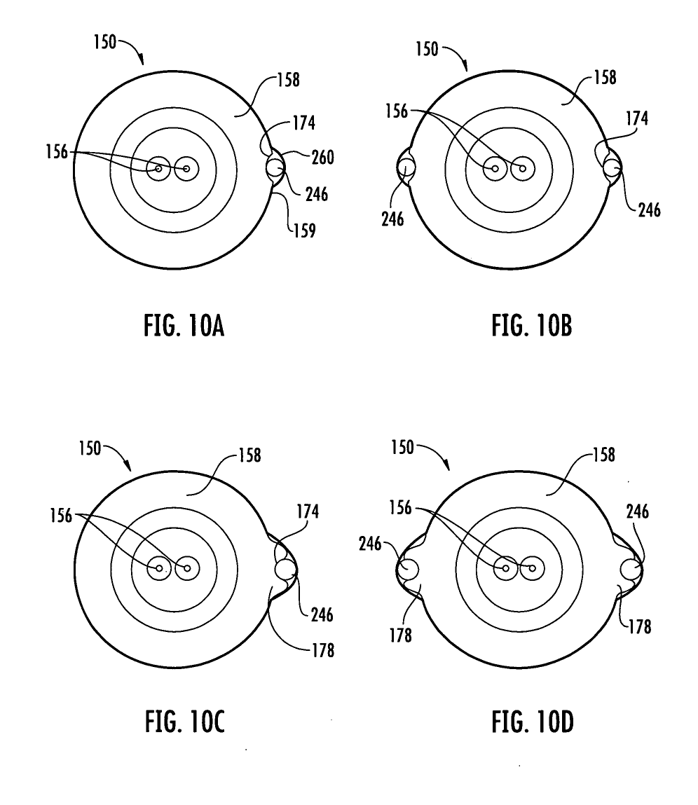

FIG. 10A through FIG. 10D are cross-sectional views of an example embodiment of a round fiber optic cable 150 that carries two optical fibers 156 and that is adapted for use with optical fiber connector assembly 10 of the present invention. Generally, fiber optic cable 150 carries one or more fibers 156 and the two-fiber cable is shown merely by way of example. Protective cover 158 is shown as defining a circular cross-section, as opposed to the “figure eight” cross-section defined by the fiber optic cable 150 of FIG. 3 through FIG. 5. Protective cover 158 can define other cross-sectional shapes, such as elliptical, rectangular, etc.

FIG. 10A illustrates an example embodiment wherein a groove 174 is formed in protective cover 158, wherein the groove travels along at least a portion of the length of fiber optic cable 150 and is sized to accommodate at least a portion of wire 246. In an example embodiment, wire 246 is partially seated in groove 174 and partially extends out beyond protective cover outer surface 159. One or more securing members 260, such as one or more heat-shrink wrap sections, circumferentially surround protective cover 158 at one or more locations along the length of fiber optic cable 150 to hold wire 246 within groove 174. As mentioned above, wire 246 is preferably loosely held within groove 174 so that the wire can move as fiber optic cable 150 is bent.

FIG. 10B is similar to FIG. 10A and illustrates an example embodiment wherein fiber optic cable 150 includes two grooves 174 so that the fiber optic cable supports two wires 246, such as in the example embodiment discussed above in connection with FIG. 8. More than two grooves 174 can also be formed to accommodate corresponding more than two wires 246.

FIG. 10C illustrates an example embodiment of fiber optic cable 150 that includes a raised portion 178 on protective cover outer surface 159 and that runs along at least a portion of the length of the fiber optic cable. A groove 174 is formed in raised portion 178 and is sized to accommodate at least a portion of wire 246. One or more securing members 260, such as one or more heat-shrink wrap sections, circumferentially surround protective cover 158 and raised portion 178 to hold (e.g., loosely hold) wire 246 within the raised-portion groove 174.

FIG. 10D is similar to FIG. 10C and illustrates an example embodiment wherein fiber optic cable 150 includes two raised portions 178 with respective grooves 174 formed therein so that the fiber optic cable supports two wires 246. More than two raised portions 178 with grooves 174 can also be formed to accommodate corresponding more than two wires 246.

Connector Adapter with RFID Antenna

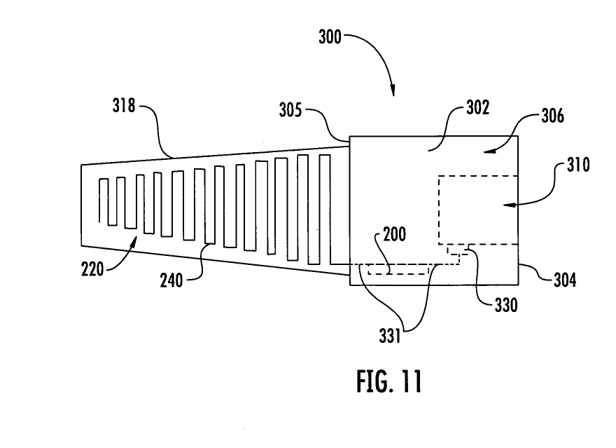

FIG. 11 is a schematic side view of an example connector adapter 300 that includes an RFID tag 200. Connector adapter 300 includes a flange 318 that extends along one of sides 306 and beyond back end 305. Flange 318 is adapted to support at least a portion of antenna 220 of RFID tag 200. In an example embodiment, flange 318 includes a serpentine section 240 of antenna 220 that is formed, for example, by a zig-zag metal film. Also in an example embodiment, side 306 supports a portion of antenna 220.

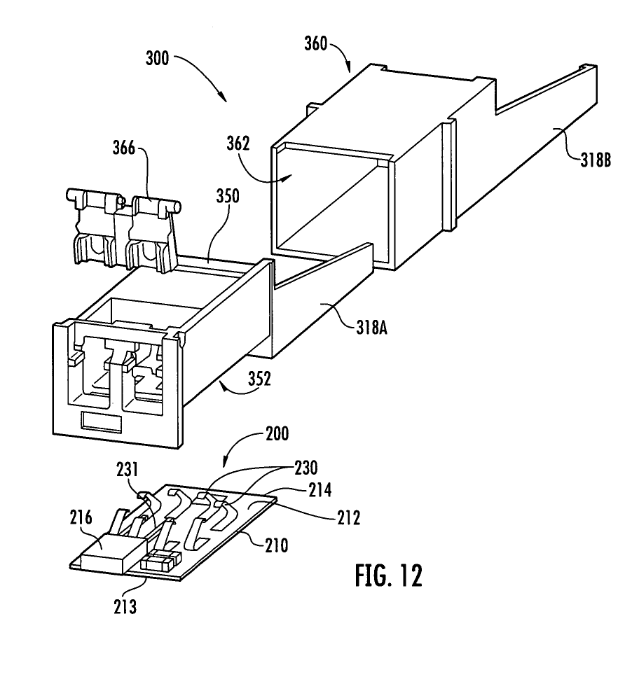

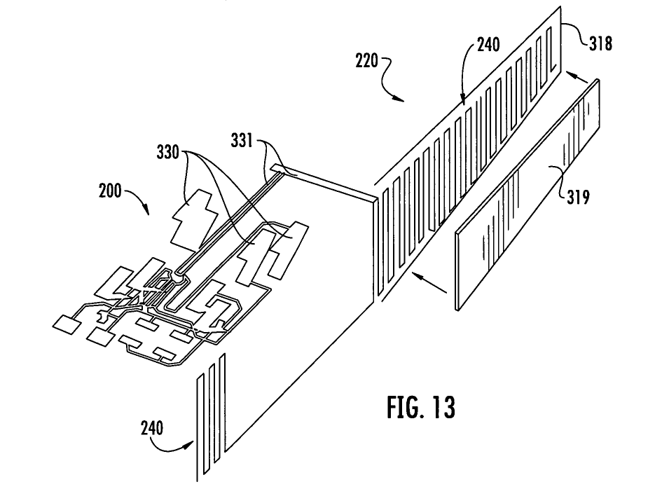

FIG. 12 is an exploded perspective view of an example connector adapter 300 similar to that shown in FIG. 11. The connector adapter of FIG. 12 includes a connector inner housing 350 having a bottom 352, and a connector outer housing 360. Connector outer housing 360 defines an open interior 362 and surrounds at least a portion of the connector inner housing 350. Connector adapter 300 also includes a fiber aligner member 366 that fits within inner housing 350. RFID tag 200 attaches to inner housing bottom 352. Inner and outer housings 350 and 360 each include respective flanges 318A and 318B that join to form a single flange 318.

FIG. 13 is a perspective diagram of an example RFID tag 200 and antenna 220 connected thereto for use in the connector adapter 300 of FIG. 11 and FIG. 12, wherein the antenna is at least partially supported by flange 318. In an example embodiment, a thin film of material 319, such as MYLAR, is used to cover the portion of antenna 220 that resides on flange 318.

### Telecommunications Assembly

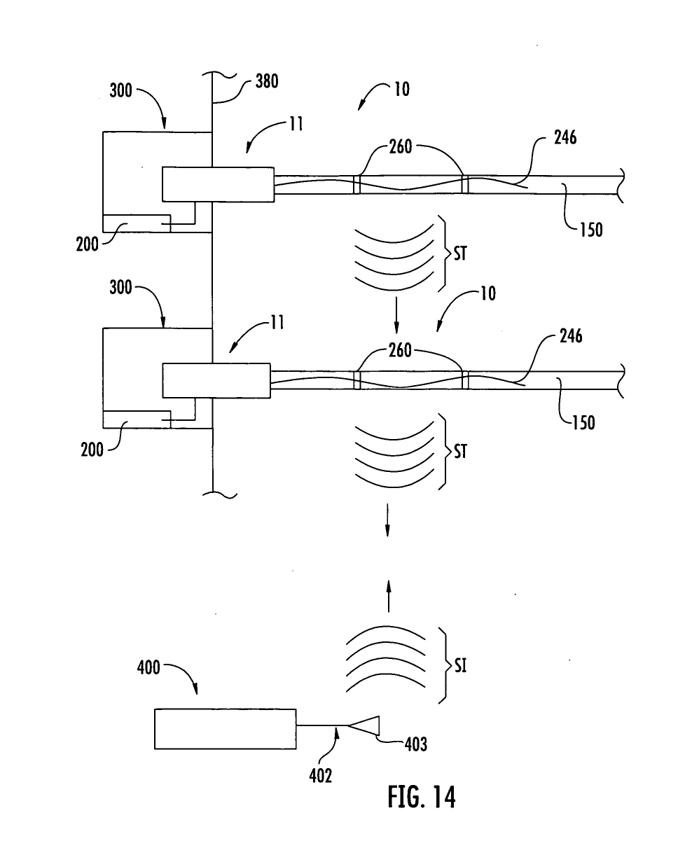

FIG. 14 is a schematic close-up cross-sectional diagram of a portion of a telecommunications assembly in the form of a patch panel assembly 380. Patch panel assembly includes a number of connector adapters 300 with optical fiber connector assemblies 10 (shown in side view) engaged therewith (see, e.g., FIG. 6). FIG. 14 also shows an RF reader 400. RF reader 400 has a RFID antenna system 402 with at least one antenna element 403. RF reader 400, and in particular antenna system 402, is preferably arranged relative to patch panel module 380 so that in response to interrogation signals SI from the RF reader, it can receive RFID tag signals ST from RFID tags 200. Note that antennas 220 for the RFID tags 200 include wires 246 supported by connector 11 and fiber optic cable 150, as described above.

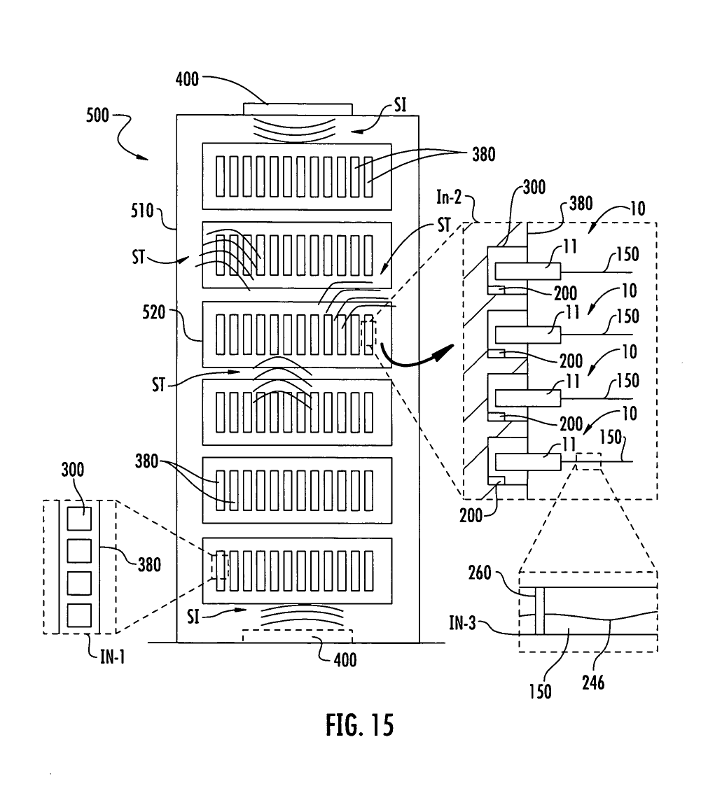

FIG. 15 is a schematic diagram of an example embodiment of a telecommunications assembly 500 with RFID capability and that employs the optical fiber connector assemblies 10 of the present invention. Telecommunications assembly 500 includes a telecommunications rack 510 that supports a number of patch panel shelves 520 that in turn support an even larger number of patch panel assemblies 380 that in turn support an even larger of connector adapters 300 (see first inset In-1). The second inset In-2 in FIG. 15 is similar to FIG. 14 and shows a close-up side view of a portion of one of the patch panel assemblies 380 that includes a number of connector adapters 300 with optical fiber connector assemblies 10 engaged therewith via corresponding connectors 11. At least one RF reader 400 is disposed within, upon or adjacent telecommunications rack 510 so that it can receive RFID tag signals ST from RFID tags 200 within telecommunications rack 510 via respective antennas 220 in response to interrogation signals SI.

In example embodiments such as those discussed above, RFID tags 200 are supported by connector assembly 10 (e.g., by connector 11) or by connector adapter 300, or RFID tags are respectively supported by the connector assembly and the connector adapter. Two RF readers 400 are shown by way of example as integrated with telecommunications rack 510, with one RF reader one atop the communications rack and one at the bottom. In general, one or more RF readers 400 can be used, and can be integrated with or simply arranged adjacent to telecommunications rack 510 in any number of ways.

Because of the large number of connector adapters 300 and connectors 11 within the relatively small space associated with telecommunications rack 510, the optical fiber connector assemblies 10 of the present invention provide RFID tags 200 with improved RF communication ability. This is accomplished by respective wires 246 having sufficient length L_{W} so that the corresponding RFID tags 200 can receive interrogation signals SI and adequately extract power therefrom. Wires 246 also enable or improve the ability of antennas 220 to send (reflect) respective tag signals ST to RF reader 400 with enough strength so that the RF reader can read information from the large number of interrogated RFID tags. The RF reader 400 can also write information to the RFID tags 200 using write signals SW because antennas 220 have a sufficient length as provided by wires 246 supported by connector assembly 10.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical fiber connector assembly that provides radio-frequency antenna capability for at least one radio-frequency identification (RFID) tag, comprising:
a fiber optic cable having an end, a length and an outer surface, and at least one optical fiber;
an optical fiber connector operably connected to the fiber optic cable end; and
at least one wire either electrically connected to the at least one RFID tag or configured to electrically connect to the at least one RFID tag, wherein the at least one wire runs along a portion of the fiber optic cable length so as to serve as at least a portion of an RFID antenna for the at least one RFID tag.

2. The optical fiber connector assembly of claim 1, wherein the at least one wire is loosely held to the fiber optic cable to accommodate movement of the fiber optic cable.

3. The optical fiber connector assembly of claim 2, wherein the fiber optic cable outer surface includes at least one groove that at least partially accommodates the at least one wire.

4. The optical fiber connector assembly of claim 2, wherein the at least one wire resides adjacent the fiber optic cable outside surface.

5. The optical fiber connector assembly of claim 1, wherein the at least one RFID tag is included in the optical fiber connector and is electrically connected to the at least one wire.

6. The optical fiber connector assembly of claim 1, wherein the at least one wire includes a first wire and the at least one RFID tag includes a first RFID tag, the assembly further comprising:
a connector adapter configured to operably engage with the optical fiber connector and that includes the first RFID tag and a first electrical contact electrically connected to the first RFID tag; and
a connector electrical contact supported by the optical fiber connector and electrically connected to the first wire and configured to electrically contact the first electrical contact when the connector and connector adapter operably engage so that the first wire serves as at least a portion of the RFID antenna for the first RFID tag.

7. The optical fiber connector of claim 6, wherein the at least one wire further includes a second wire and the at least one RFID tag includes a second RFID tag, and wherein:
the connector supports the second RFID tag; and
the second wire is electrically connected to the second RFID tag and serves as the portion of the RFID antenna for the second RFID tag.

8. The optical fiber connector assembly of claim 1, further including:
a connector adapter configured to operably engage with the optical fiber connector and that includes the at least one RFID tag and a flange portion that includes at least a portion of an antenna connected to the at least one RFID.

9. The optical fiber connector assembly of claim 1, wherein the at least one wire has an exposed section with a length L_{W} in a range defined by 10 cm≦L_{W}≦15 cm.

10. A telecommunications assembly with RFID capability, comprising:
a plurality of connector assemblies according to claim 1;
plurality of connector adapters having respective RFID tags and that are operably engaged with the plurality of connector assemblies so that the RFID tags are respectively electrically connected to respective wires of the corresponding connector assemblies; and
at least one RF reader arranged in relation to the wires so as to operably communicate with the plurality of RFID tags via the respective wires.

11. The telecommunications assembly of claim 10, wherein one or more of the RFID tags have respective antennas, and wherein the respective wires of said one or more RFID tags are electrically connected to the respective antennas.

12. The telecommunications assembly of claim 10, wherein the respective wires of said one or more RFID tags serve as substantially an entire antennas for the corresponding one or more RFID tags.

13. An optical fiber connector assembly that provides radio-frequency antenna capability for at least one radio-frequency identification (RFID) tag, comprising:
a fiber optic cable having an end, a length and an outer surface;
an optical fiber connector operably connected to the fiber optic cable end;
a connector adapter configured to operably engage the optical fiber connector and that includes the at least one RFID tag; and
at least one wire that runs along a portion of the fiber optic cable length and that is configured to electrically connect to the at least one RFID tag when the connector and connector adapter are operably engaged so as to serve as at least a portion of an RFID antenna for the at least one RFID tag.

14. The optical fiber connector assembly of claim 13, wherein the at least one wire serves as substantially an entire RFID antenna for the at least one RFID tag.

15. The optical fiber connector assembly of claim 13, wherein the at least one wire is loosely held to the fiber optic cable to accommodate movement of the fiber optic cable.

16. The optical fiber connector assembly of claim 13, wherein the fiber optic cable includes at least one groove, and wherein the at least one wire is at least partially supported within the at least one groove.

17. A method of providing radio-frequency antenna capability for at least one radio-frequency identification (RFID) tag having an integrated circuit chip, comprising:
providing a connectorized fiber optic cable having a length and a connector;
disposing at least one wire to run from the connector and along an outside portion of the fiber optic cable length;
electrically connecting the at least on wire to the integrated circuit chip of the RFID tag so as to serve as at least a portion of an RFID antenna for the at least one RFID tag.

18. The method of claim 17, further comprising:
supporting the at least one RFID tag by the connector.

19. The method of claim 17, further comprising:
supporting the at least one RFID tag by a connector adapter that is configured to operably engage with the connector; and
operably engaging the connector and connector adapter so as to cause the at least one wire to be electrically connected to the integrated circuit chip.

20. The method of claim 19, where electrically connecting the at least one wire to the integrated circuit chip further comprises electrically connecting the at least one wire to an RFID antenna section that is electrically connected to the integrated circuit chip.
